(19) United States
(12) Patent Application Publication
(10) Pub. No.: US 2006/0160562 A1
(43) Pub. Date: Jul. 20, 2006

(54) Automatic deactivation/activation of cellular phones in restricted areas

(76) Inventors: Harvey Edd Davis, Trenton, TX (US); Andrew Marshall, Dallas, TX (US); Tito Gelsomini, Plano, TX (US)

Correspondence Address: TEXAS INSTRUMENTS INCORPORATED, P O BOX 655474, M/S 3999, DALLAS, TX, 75265, US

(21) Appl. No.: 11/305,503

(22) Filed: Dec. 16, 2005

Related U.S. Application Data
(60) Provisional application No. 60/636,502, filed on Dec. 16, 2004.

(51) Int. Cl. H04M 1/00

(52) U.S. Cl. 455/550.1

(57) ABSTRACT

Means of controlling cell phone features or usage are described. In the first embodiment, transmitter is a low-power Bluetooth, or similar data transmitter, local to the venue or area in which control of, for example, ringer volume is desired. A receiver receives data only when in the venue, and causes controller to disable features such as the ringer or camera. A second embodiment uses RF or magnetic induction signaling loops at physical access points of a venue. Dual loops at each access point signal to the phone the desired command, and the order of passage through the two loops determines whether the command is activated or deactivated. A third embodiment has a computer which uses a unique cell phone identifying number, time of day, and a timeout value as entry variables to a secret algorithm which generates a code number. Cell phone also has the same algorithm and accurate time of day. When the code number is input to cell phone within one minute of generation, the desired function, such as the camera, is disabled. A second code number is generated which is entered to restore normal operation of the cell phone when the user exits the facility. Alternatively, normal operation is restored after the timeout period, even if the second code number is not entered. A fourth embodiment allows the user to enter a timeout value from the local keypad. After the desired time, as determined by timer, the deactivated feature—for example the ringer—will resume normal operation.

### CROSS-REFERENCE TO RELATED APPLICATION

This application claims priority under 35 U.S.C. 119 of provisional application Ser. No. 60/636,502, filed Dec. 16, 2004, the entirety of which is incorporated herein by reference.

This disclosure relates to cellular telephone handsets and systems in general, and, in particular, to a method and apparatus for automated activation/deactivation of various functions of such telephone handsets.

### BACKGROUND

Cellular telephone usage and capabilities have both increased rapidly in recent years. Text messaging, instant messaging, web access, and integrated cameras are added features which go well beyond simple voice communication. Even as capabilities increase, phone size continues to decrease, so many people have their cellular phone with them essentially all the time.

As the number of cell phone users continues to increase, and added features drive additional usage, there is a growing problem of distraction or annoyance caused by inappropriate ringer activation or other usage during concerts, meetings, etc. The current solution to the ringer annoyance problem is the vibrate or silent modes, but either must be selected by the user, and such selection is too easily forgotten. Also, selection of vibrate or silent often leads to missed calls after the event, as the user forgets to re-activate the ringer.

The addition of cameras to cell phones has caused additional problems concerning privacy and security. Many areas of business and commerce forbid or restrict still or video photography. For example, a factory may have proprietary processes it doesn't want visitors to document; presentations in a meeting often include confidential information which should not be recorded; performing artists prohibit photography or other recording at performances. The cameras on cell phones, due to their necessarily small size, are barely discernible in some instances, making it ever more difficult to prevent unwanted photography if cell phones are allowed on the premise.

Cell phone usage in some environments can be a significant threat to safety. For example, radio frequency interference (RFI) from an operating cell phone may interfere with navigation or other computing devices on aircraft or ships. Relying on users of cell phones to turn off their phones does not guarantee all will be turned off.

### SUMMARY

The invention provides an apparatus and method for activating and deactivating, either by the user or by a remote or local control mechanism, cell phone features or subsystems such as the ringer, camera, and radio frequency (RF) generators. Several means of feature deactivation on entering an area are described, including detection of a local wireless signal blanketing the subject area, entrance and exit loops through which the cell phone must pass and receive deactivate and activate commands respectively, manually-entered deactivate/activate code numbers or words, and a timer with secure or unsecured setting of deactivation time period.

Blanketing an area with a local, confined RF signal is particularly effective for soft disable (that not posing a safety or security threat) such as ringer and/or camera disable in a performance venue. The cell phone receives a deactivate signal generated by a low-power transmitter in the venue, using either the same receiver it uses for communication with the cell network, or a secondary receiver such as Bluetooth or 802.11 WLAN.

Signaling loops at the entrance and exits of a venue can also transmit to the cell phone the deactivate/reactivate commands, using even lower power local transmission covering only the area of the loop. Dual loops at each access point signal to the phone whether entry or exit is occurring, allowing unambiguous deactivation and activation, respectively.

In some environments cell phone camera usage or RF generation poses a security or safety concern. A local RF signal to deactivate features may not always be feasible, for example due to the large physical area to be covered or the requirement that no RF fields be used in an area (such as an aircraft). Manual deactivation of features or subsystems can alternatively be accomplished by entering a multi-digit numeric or alpha code on the cell phone keypad. This code is entered by a person of authority controlling access to the area (for example, the security guard at a company, or a security agent at an airport). The deactivate code is generated by a computer program, which provides a deactivate code unique to the specific cell phone. Each deactivate code also has a unique reactivate code effective only on that single cell phone. Optionally, a time-out period reactivates features after a preset time period, eliminating the need for entry of a reactivate code.

A non-secure timeout period may also be entered by the user, to reactivate a feature which he has manually deactivated. For example, on selecting vibrate (ringer off) before a concert starts, the user may also program the number of hours or minutes before the ringer reverts to normal operation.

Advantages over known art include relative simplicity and low cost of implementation (some embodiments require only modification to the operating software of the phone). There is also little or no impact to the existing cellular transmission infrastructure and its operating protocols, software and hardware.

### BRIEF DESCRIPTION OF THE DRAWINGS

FIG. 1 is a block diagram of a system utilizing a local low-power signal transmitter broadcasting a deactivate command to cell phones within a limited coverage area.

FIG. 2 is a block diagram of a system using signaling loops at each entrance and exit of a venue, to deactivate/reactivate cell phone usage or features.

FIG. 3 is a block diagram of a system using deactivation codes locally entered on the cell phone keypad, with reactivation by similar entry of a second unique code or after a preset timeout.

FIG. 4 is a block diagram of a cell phone with modification to internal operating code or circuitry which allows entry of a preset timeout period, after which ringer operation resumes.

Throughout the drawings, like elements are referred to by like numerals.

### DETAILED DESCRIPTION OF THE EMBODIMENTS

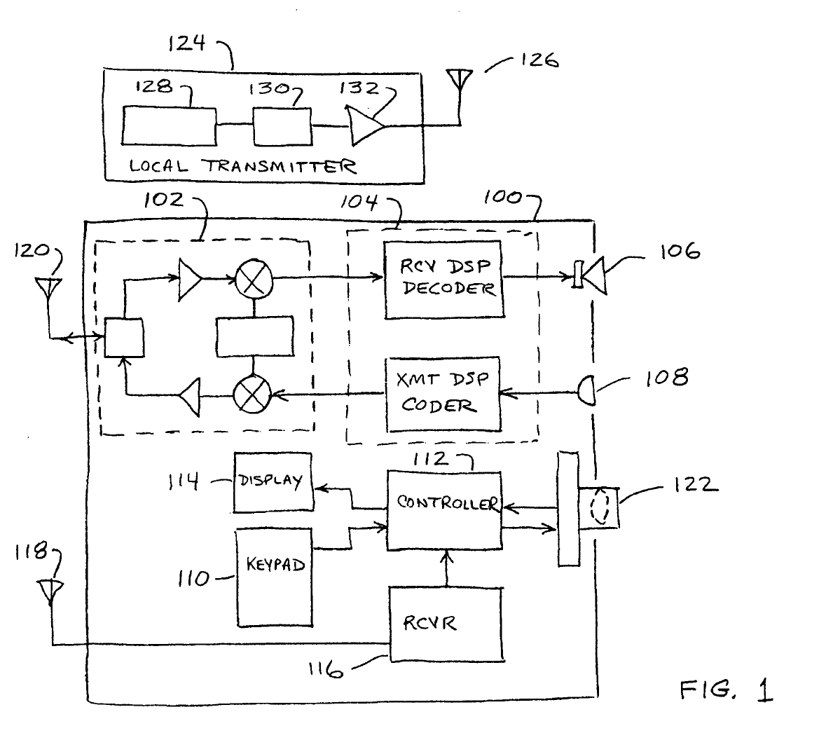

In FIG. 1, the basic functionality of cell phone 100 comprises radio frequency (RF) section 102, baseband digital signal processing (DSP) codec section 104, speaker 106 (which also outputs ringer tones), microphone 108, keypad 110, display 114, and control section 112. These subsystems are familiar to those skilled in the art, and can be partitioned or configured in various ways while still providing the basic cell phone function.

The heart of the cell phone operation is microcontroller 112, which has as input data from the local keypad 110, data from the cellular system (operational data and web page data), and data from internal functional blocks. It provides output data to the channel selection subsystem for tuning, the DSP/codec for voice coding/decoding, the transmitter for upstream data requests, and the display system. Additional data flows are common in the variety of cell phone system architectures deployed.

A camera 122 connects to the controller 112 and the display system 114. The controller 112 sends various commands to the camera to modify its operation and handle movement of image data to and from memory and the display 114. The controller 112 therefore has the ability to disable camera operation if desired.

Similarly, controller 112 has the ability to disable the ringing signal sent to the DSP decoder (which then goes to the speaker for audible output).

Transmitter 124 is a Bluetooth, 802.11b, 802.11g, or similar low-power data transmitter, located in the venue desiring control of cell phone functions. Data generator 128 has a driving connection with data modulator 130, which in turn drives output amplifier 132 feeding antenna 126.

Data from data generator 128 adheres to a protocol which includes data types for one or more functions to be disabled, time period for disable of each function, GPS coordinates of venue, and radius of effect. Typical data types for disable are ringer and camera functions. Time period of disable is optional; the default is disable if receiving the disable signal, and enable on loss of signal. By having a disable time period, the disable transmitter need not be active the entire period of the performance; rather it can send disable commands prior to the performance start, then cease transmission. Alternatively, the disable signal of a large venue may be present only at the entry points of the venue. On entry, each cell phone receives the disable and a timeout value after which normal operation resumes. The timeout can be either a time period (number of minutes) or a clock time value, as cell phones universally have knowledge of clock time.

Data from generator 128 is modulated in data modulator 130 then amplified in 132 and coupled to antenna 126 for transmission.

Receiver 116 is added to the cell phone for reception of the signal from transmitter 124. The output data from receiver 116 is passed to controller 112, where the disable protocol is decoded and appropriate commands are generated to disable the ringer and/or camera or other functions. While a separate antenna 118 is shown for this receiver, alternatively it can use the existing antenna 120.

Many cell phones now include a GPS receiver for location awareness. The GPS coordinates of the venue and a radius of effect may optionally be transmitted along with the disable signal. Presuming a phone with GPS capability, the phone can then compute whether it is inside or outside the radius of effect, and when outside resume normal operation.

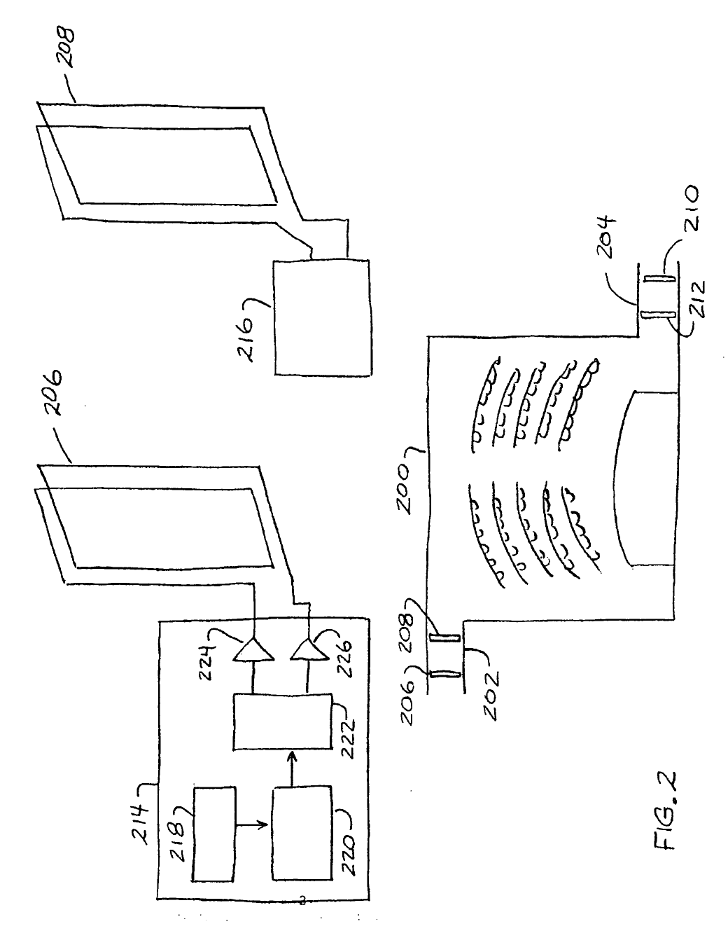

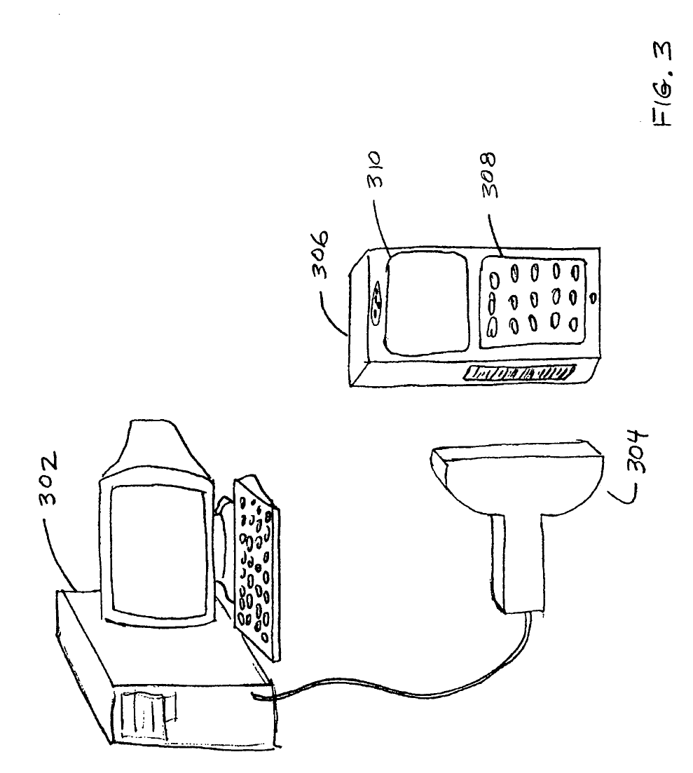

In FIG. 2, a system using transmission loops is shown. Transmission loops are used around doorways or other points of controlled access to a space, for example the venue 200. Venue 200 as shown has entry/exit at 202, where loops 206 and 208 are deployed, and at 204, where loops 210, 221 are deployed. Alternatively, a flat antenna on the side of a narrow corridor might be employed rather than a loop, with similar benefit. The advantage of a system using such loops or other close-proximity data transmission mechanism is that the required transmitter power is greatly reduced due to the controlled and short range over which communication is necessary.

If a single loop is used, for example transmitting a disabling signal to a user cell phone, the same disable action will occur regardless of direction through the loop. Thus a theater patron, whose cell phone was disabled on entry, will be disabled a second time on exit. Various partial solutions exist, for example transmitting disables while patrons are entering and disables as they exit. The patron who leaves early, while disables are still being sent, will unfortunately leave the venue with a disabled phone. A timeout value as described above would mitigate this problem.

An alternative loop system has two loops at each access point, each transmitting the same disable or enable commands as described above, but with an added data field indicating whether the loop is the outer or inner loop. The outer loop is the first loop encountered on entry; the inner loop is the first loop encountered on exit. It is therefore easy for the receiver and associated logic to determine whether entry or exit is occurring, by the order in which the signals from the two loops are received. Receiving, for example, a disable ringer command on entry (outer, inner loop in sequence), and the ringer would be disabled. Receiving the same disable command on exit, (inner, outer loop in sequence) would restore normal operation to the phone. It is important in such a system to insure the loops are far enough apart to preclude overlap of transmitter coverage area.

Loop data transmitter 214 generates signals for loop 206. A non volatile memory 218, programmed on installation or when parameter changes are required, holds command data as described above, such as feature to be disabled, time period of disable, GPS position, and radius of effect. This data is used by data packet generator 220 which generates data messages in an appropriate protocol. Generator 220 also has a real-time clock allowing computation of time to release the disable, if this approach is used. Data modulator 222 generates a modulated RF signal which is then amplified by buffer 224 and applied to differential driver 226, which drives the loop 206 current in an alternating fashion.

The RF frequency of a close-proximity loop system such as this can be very low compared to communication systems requiring greater range. For example, a carrier frequency in the tens of Kilohertz can easily travel a few feet by magnetic induction even with very low transmit power. Use of magnetic induction with relatively low carrier frequency significantly lessens the cost of the receiver circuitry required in the cell phone. It also provides a wireless data link without requiring a licensed frequency band, or the strict transmit parameter and protocol control of unlicensed systems such as 802.11 or Bluetooth.

A typical magnetic induction receiver is shown in FIG. 5. The modulated magnetic field from the loop is converted to an alternating current in inductive pickup 502. The signal is amplified in 504. It is then filtered by a narrow-band band pass filter 506 which is tuned to the carrier frequency of transmitter 214. This filter passes the desired signal and rejects interference from other signal sources. Data detector 508 then further processes the amplified and filtered signal to demodulate the data signal for output. This type of receiver is very similar to typical infra-red (IR) data receivers used in consumer electronics remote control systems. Many cell phones include IR data transceivers; such circuitry may be adapted at low cost to serve also as a magnetic induction receiver.

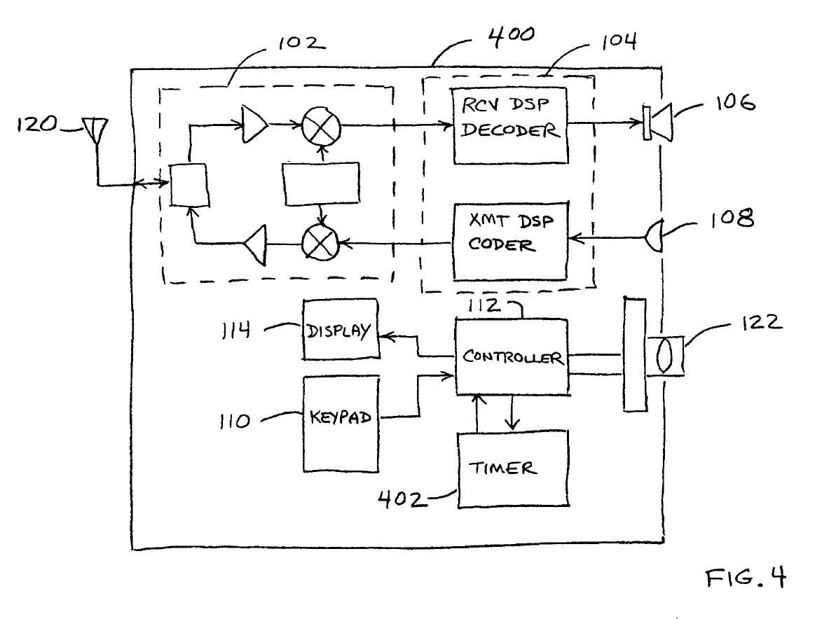

FIG. 3 shows a system for local entry on the cell phone keypad of a code to either disable or enable functionality. A computer 302 has an attached bar code reader 304, which reads the serial number or other unique identifying number from the cell phone. The computer uses this unique identifying number and a changing, universally known parameter (such as time of day to one minute accuracy) as entry variables to an algorithm which generates a code number. This code number, when entered on keypad 308 of cell phone 306 within one minute of generation, disables the desired function, such as the camera. Display 310 provides visual feedback of the entered code number, and acknowledgement of the desired result (deactivation or activation). At the same time the computer generates the code number used to deactivate, a second code number is generated which restores normal operation when it is entered by the security guard at the exit.

The computer system 302 is typically at a controlled access entry to a facility, and is under the control of a trusted operator such as the security personnel at that location. When a person desires entry with a cell phone (which can be detected by a normal metal detector at the entrance), the code word is generated and entered to disable the phone or function. On exit, the second code number is entered to restore normal operation of the phone.

A third variable sets a time period after which normal operation resumes even without the entry of the second code, and is optionally input to the algorithm. Use of this option generates a disable code number which is active only for a certain time. Use of this option avoids the frustration and inconvenience of a visitor needing to return to the facility to have his phone reactivated. For most facilities, presuming camera disable only, a 12 to 24-hour timeout might be a good balance between security and customer/visitor inconvenience.

The algorithm is secret but known to the cell phone manufacturers, and the appropriate software to execute the reverse algorithm is included in any phone desiring this control capability. Keys changing with time, or even modifications to the algorithm, allow recovery should the encrypted system be compromised.

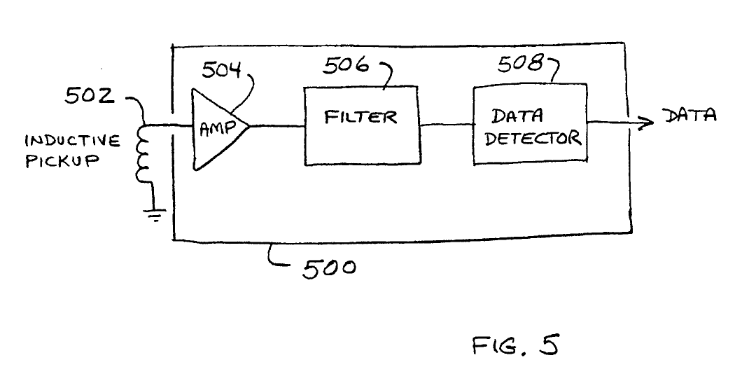

FIG. 4 is a block diagram of a cell phone, essentially identical to that described in FIG. 1, but not including any receiver for data transmitted from a Bluetooth, 802.11, magnetic loop, or similar transmitter.

Timer 402 is activated by user entry to keypad 110, with confirmation of entry and activation by display 114. Whenever the user selects vibrate or off as the ringer mode, he is given the option to set a time value which is input to timer 402. If a timer value is entered, normal ringer operation resumes at the end of the time period.

The timer is implemented either in hardware as shown by block 402, or alternatively, as software modifications in controller 112, since controller 112 has knowledge of real time.

The cell phone features modified with this approach must be those having no security impact, since the phone user is in control. Ringer disable with timeout will be welcomed by most movie or show patrons. Air travelers will also appreciate the phone turning itself back on after a time period somewhat longer than the flight.

Those skilled in the art to which the invention relates will appreciate that yet other substitutions and modifications can be made to the described embodiments, without departing from the spirit and scope of the invention.

1. Apparatus and methods as shown and described.
